(19) United States
(12) Patent Application Publication
(10) Pub. No.: US 2008/0082455 A1
(43) Pub. Date: Apr. 3, 2008

(54) System and method for communicating charging data records

(76) Inventors: Yigang Cai, Naperville, IL (US); Chun Guang Xu, Beijing (CN)

Correspondence Address: HARNESS, DICKEY & PIERCE, P.L.C., P.O. BOX 8910, RESTON, VA, 20195, US

(21) Appl. No.: 11/529,378

(22) Filed: Sep. 29, 2006

(51) Int. Cl. H04L 9/00

(52) U.S. Cl. 705/77

(57) ABSTRACT

A system and methods for communicating charging data records (CDRs) used to bill for services provided by an Internet Protocol Multimedia Subsystem (IMS). The methods provide a removed field indication in reduced partial CDRs as well as an improved redundancy mechanism for communicating partial CDRs.

### BACKGROUND OF INVENTION

1. Field of the Invention

The present invention is related to a system and method for telecommunications. More particularly, the present invention relates to a system and method for communicating charging data records (CDRs) used to bill for services provided by an Internet Protocol Multimedia Subsystem (IMS).

2. Background Information

3GPP Release 6 standards define an offline charging architecture to provide billing services related to use of an IMS network 100.

Referring to FIG. 1, the offline charging architecture includes a Charging Trigger Function (CTF) 110, Charging Data Function (CDF) 120, a Charging Gateway Function (CGF) 130 and a Billing Domain (BD) 140. One skilled in the art will appreciate that the BD 140 may also be a billing system and/or a billing mediation device.

The CTF 110 generates charging events by monitoring network resource usage. The CTF 110 receives information from various service elements. This information includes, but is not limited to, charging information relating to the services provided by the service element 105 to various subscribers. The CTF 110 is the focal point for collecting the charging information pertaining to charging events and charging sessions related to a service element 105, assembling this charging information into charging sessions and charging events, and sending the charging sessions and charging events to the CDF 120. Charging sessions and charging events are well-known in the art. One skilled in the art will readily appreciate that the CTF 110 generally includes an accounting metrics collection function and an accounting data forwarding function.

The CDF 120 receives the charging sessions and charging events from the CTF 110 via the Rf interface. The CDF 120 uses the information contained in the charging sessions and charging events to construct and/or modify Charging Data Records (CDRs). The CDF 120 then transfers the CDRs to at least one CGF 130 via the interface Ga.

The CGF 130 acts as a gateway between the IMS network 100 and the BD 140. The CGF 130 uses the Bx interface to transfer the CDRs to the BD 140.

Once the CDRs are received by the BD 140, the BD 140 processes the CDRs to generate subscriber bills.

In session based charging, the CDF 120 opens a CDR when an initial charging event (i.e., an event specifying the start of a charging session) is received. The CDF 120 adds information to an opened CDR in response to receiving interim charging events, which may occur during a charging session. The CDF 120 may then close a CDR for a variety of reasons. The closing of the CDR may be based on the configuration on the CDF 120. For example, the CDF 120 may close a CDR based on one or more of the following: a CDR time limit; a CDR volume limit; a limit of change on charging conditions; an end of user session (i.e., reception of the final charging event describing the charging session termination); and implementation limits (e.g. memory size).

If the CDF 120 closes a CDR, but the charging session remains active, a subsequent CDR is opened. Hence multiple “partial CDRs” may be needed to completely describe the charging session for charging purposes. As such, the opening and closure of CDRs may occur asynchronously to the reception of the charging events.

Using a reduced format for partial CDRs reduces the size of partial CDRs. The reduced format for partial CDRs removes unnecessarily repeated information from partial CDRs. The reduced format for partial CDRs includes information that changes from a previous CDR to the current CDR as well as mandatory information. According to 3GPP Release 6 standards, the only mandatory CDR field is “Record Type”. As such, the information removed in the reduced format for partial CDRs may be reconstructed from fields in previous partial CDRs.

The following two formats of partial CDRs are generally described in the 3GPP Release 6 standards. The first format is referred to as a Fully Qualified Partial CDR (FQPC) and is a partial CDR that contains a complete set of CDR Fields. The second format is referred to as a Reduced Partial CDR (RPC) and is a reduced format partial CDR that contains the Mandatory fields (M) as well as changes occurring in any other field relative to the previous partial CDR.

Even though the 3GPP Release 6 standard defines the above offline charging architecture and generally describes the two formats of partial CDRs, the standards do not identify and/or address problems related to implementing and communicating RPCs. In particular, the 3GPP Release 6 standard fails to indicate how a component receiving a RPC can identify a removed and/or reduced field in a received RPC and how a component can reconstruct a FQPC from a RPC if the component receiving the RPC has not also received a previous FQPC.

It is also noted that a redundancy mechanism of CDR transportation between CDF and CGF is presented in the 3GPP 32.295 standard. This redundancy mechanism improves transportation of CDRs from a CDF to CGFs. However, the RPCs of a session may arrive at different CGFs when the redundancy mechanism described in the 3GPP32.295 standard is utilized. As such, one CGF has to retrieve previously sent partial CDRs from other CGFs to restore a received RPC. However, the CGF may not know where the previously sent partial CDRs are located and thus, this method of restoring a received RPC is not efficient.

### SUMMARY OF THE INVENTION

An example embodiment of the present invention provides a method of communicating CDRs in an IMS. The method includes the steps of comparing fields of a previous partial CDR to fields of a current partial CDR; providing a removed indication in the current partial CDR for each field of the previous partial CDR that is not included in the current partial CDR; and sending the current partial CDR.

Another example embodiment of the present invention provides a method of communicating charging data records (CDRs) in an Internet Protocol Multimedia Subsystem (IMS). The method includes the steps of sending a first partial CDR to a first CGF; determining if the first CGF remains available to receive a second partial CDR; sending the second partial CDR to the first CGF as a reduced partial CDR if the first CGF is determined available; and sending the second partial CDR to a second CGF as a fully qualified partial CDR if the first CGF is determined unavailable.

Still another example embodiment of the present invention provides a system for communicating CDRs in an IMS. The system includes at least one Charging Gateway Function CGF receiving the CDRs; and a CDF comparing fields of a first partial CDR to fields of a second partial CDR, providing a removed indication in the second partial CDR for each field of the first partial CDR that is not included in the second partial CDR, and sending the second partial CDR to the at least one CGF.

Still another example embodiment of the present invention provides a method of reconstructing CDRs in an IMS. The method includes the steps of receiving a fully qualified partial CDR and a reduced partial CDR; comparing fields of the reduced partial CDR with fields of the fully qualified partial CDR; restoring any fields omitted from the reduced partial CDR that are included in the fields of the fully qualified partial CDR; and removing fields of the reduced partial CDR that include a removed field indication.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 is a block diagram of an offline charging architecture defined by the 3GPP Release 6 standards;

FIG. 2 is a block diagram illustrating an example logic flow triggered by a charging session of network usage according to an example embodiment of the present invention;

FIG. 3 is a flow chart illustrating a method for communicating a CDR having an indication for any removed CDR fields according to an example embodiment of the present invention;

FIG. 4 is a flow chart illustrating a method for reconstructing a FQPC from a RPC according to an example embodiment of the present invention.

FIG. 5 is a block diagram illustrating an enhancement of a CDR transportation redundancy mechanism for RPC restoration according to an example embodiment of the present invention; and

FIG. 6 is a flow chart illustrating a method of communicating CDRs according to an example embodiment of the present invention.

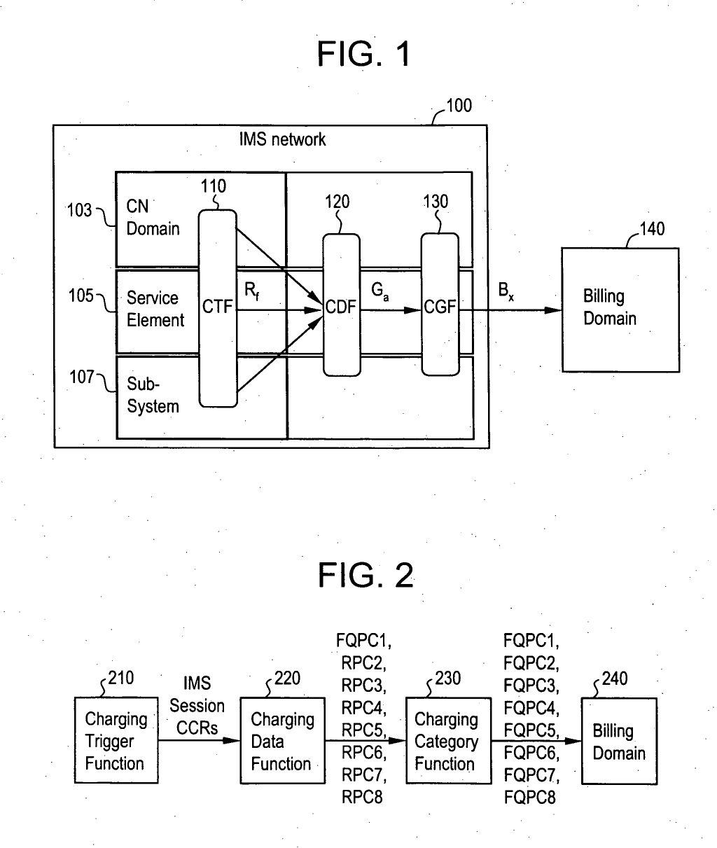

### DETAILED DESCRIPTION OF EXAMPLE EMBODIMENTS

Initially, it is noted that the 3GPP Release 6 standard referred to above in the “Background Information” section provides a mechanism for reducing a field duplicated between a first partial CDR and a second partial CDR, but does not specify how to indicate that a CDR field is no longer needed and thus, should be removed from a partial CDR. Secondly, in an IMS offline charging architecture, the entity relationship between the CDF and the CGF is likely not 1:1. For example, if a first CGF cannot be reached, then one or more CDRs will be sent to a second CGF. Therefore, partial CDRs of a session may arrive at different CGFs. However, the 3GPP Release 6 standard does not provide any guidance regarding how to restore an RPC to FQPC, when a sequence of RPCs arrive at different CGFs.

Example embodiments of the present invention identify the above problems and provide solutions thereto. These example embodiments are described referring to FIGS. 2-4.

FIG. 2 is a block diagram illustrating an example logic flow triggered by a charging session of network usage, which may result in the creation of a bill for the network usage. In particular, FIG. 2 illustrates an example logic flow between a CTF 210, a CDF 220, a CGF 230 and a BD 240.

As shown in FIG. 2, the CTF 210 generates series Account Requests (ACRs) that are sent to the CDF 220 for a charging session. ACRs are well known in the art. The CTF 210 also ensures that all the ACRs are routed to the same CDF 220.

In this example, the CDF 220 is RPC enabled and thus, is configured to support RPCs. Further, the CDF 220 is configured so that the first partial CDR of an IMS session is a FQPC, whereas the following partial CDRs, which are transmitted to a common CGF 230, are RPCs. The common CGF 230 is also RPC enabled and is configured to restore all the RPCs to their corresponding FQPCs in this example. The FQPCs are then sent to the BD 240, wherein a bill for the charging events of network usage may be generated.

Based on the example logic flow described above, two example embodiments of the present invention will now be described. The first example embodiment is directed to a first aspect of the present invention and provides an “Indication of the Removed CDR field”. The second example embodiment described below is directed to a second aspect of the present invention and is directed to an “Enhancement to CDR transportation redundancy mechanism for RPC restoration”.

### Indication of the Removed CDR Field

As described above, an RPC contains all the Mandatory fields (M) and only changes occurring in any other fields relative to a previous partial CDR. A removed field is a CDR field that is no longer needed in a partial CDR, whereas a reduced field is a field that is needed in a partial CDR but is the same as an immediately previous partial CDR. For, example, if the first partial CDR FQPC has fields A, B, C and D, and a second partial CDR has fields C, D and E. According to RPC description criteria, the RPC of the second partial CDR shall be recorded as A(removed), B(removed), E. In this example, A and B are removed fields and C and D are reduced fields. Removed fields are fields used in previous partial CDR but not in a current partial CDR, whereas reduced fields are used in both the previous partial CDR and the current partial CDR that can be reduced to save the record size because the values of the fields are the same.

An example embodiment of the present invention provides an indication of a removed CDR field. Because removed CDR fields are included in an RPC with a indication and reduced fields are omitted in the RPC, a CGF 230 and/or a BD 240 receiving an RPC can readily identify a field as a reduced field or a removed field. It is very important to distinguish between removed and reduced fields during RPC restoration, because removed fields are not to be included in the restored FQPC, while the reduced fields must be included in the restored FQPC.

The indication of a removed field according to an example embodiment of the present invention complies with ASN.1 encoding rule. Generally, the encoding of a data value shall consist of four components that shall appear in the following order: Identifier octets (encoding of ASN.1 tag); Length octets; Contents octets; and End-of-contents octets. It is noted that the End-of-contents octets are not present unless the value of the length octets requires the End-of-contents octets to be present. According to an example embodiment of the present invention, to identify a removed field only Identifier Octets and Length Octets are included in CDR record for the removed field, and the Length Octets are 0.

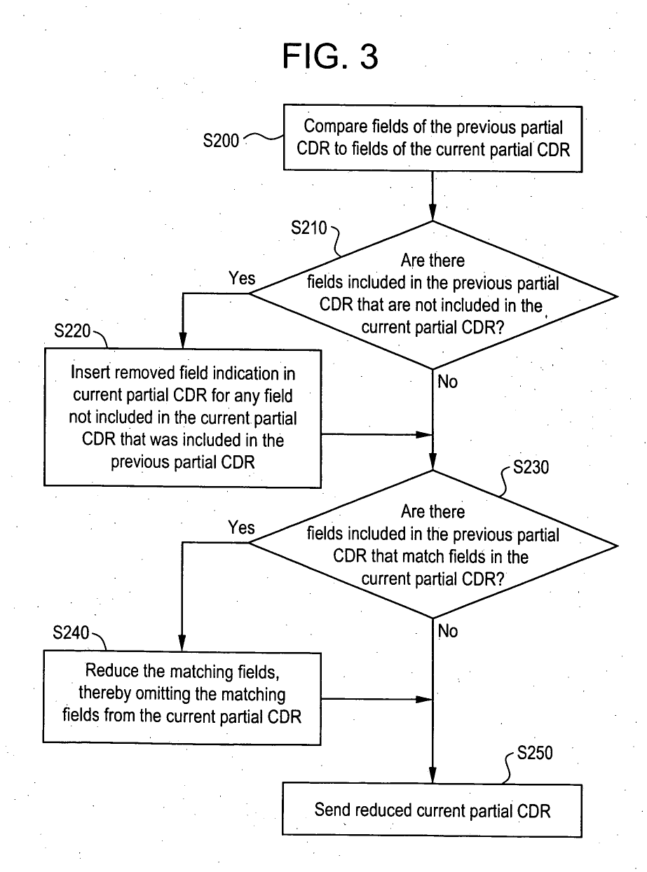

FIG. 3 is a flow chart illustrating a method for communicating a CDR having an indication of any removed CDR fields according to an example embodiment of the present invention. The method is performed by the CDF 220 shown in FIG. 2.

As shown in FIG. 3, the CDF 220 compares CDR fields of a previous partial CDR to the CDR fields of a current partial CDR in step S200. The CDF 220 then determines if there are any CDR fields included in the previous partial CDR that are not included in the current partial CDR in step S210. If there are fields included in the previous partial CDR that are not included in the current partial CDR, the CDF 220 inserts a removed field indication in the current partial CDR that indicates the removal of the fields that were included in the previous partial CDR but are removed from the current partial CDR in step S220. Processing then proceed to step S230. Alternatively, if the CDF 220 determines there are no removed fields in step S210, the flow chart proceeds directly to step S230.

In step S230, the CDF 200 determines if there are fields included in the previous partial CDR that match fields in the current partial CDR. Matching fields may be reduced. Accordingly, in step S240, if the CDF 220 determines there are matching fields, the CDF 220 reduces the matching fields, thereby omitting the matching fields from the current partial CDR. The CDF 220 then sends the current partial CDR in step S250 as a reduced partial CDR. Alternatively, if the CDF 220 determines there are not matching fields between the previous partial CDR and the current partial CDR, the flow chart proceeds directly from step S230 to step S250 and the CDF 220 sends the current partial CDR.

Because the example embodiments of the present invention described above provide an indication in a RPC for removed fields, a restoring component such as CGF 230 of FIG. 2 can readily distinguish between removed fields and reduced fields and can accurately restore a FQPC from a received RPC.

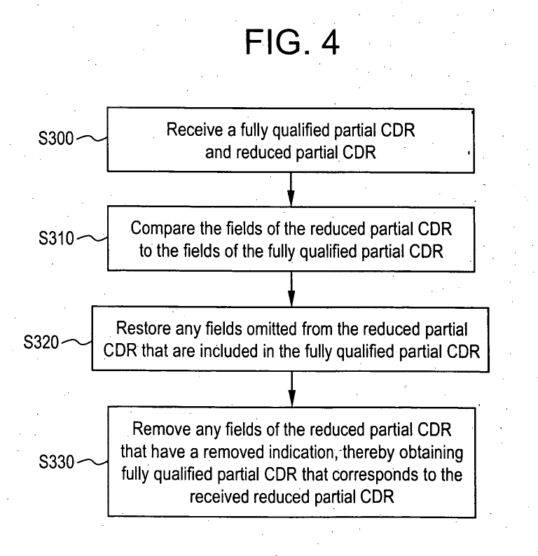

FIG. 4 is an example embodiment of a method for reconstructing a FQPC from a RPC. The method illustrated in FIG. 4 may be performed by the CGF 230 shown in FIG. 2, for example.

In step S300, the CDF 230 receives a FQPC followed by an RPC. A FQPC can be reconstructed from a received RPC by using the previously received FQPC as a template. In step S310, the reconstruction process begins by comparing the fields of the RPC to the FQPC. Any fields omitted in the RPC that are present FQPC are restored in the RPC in step S320. Lastly, in step S330, any fields including a removed field indication are completely removed from the RPC, thereby providing a reconstructed FQPC that corresponds to the RPC received in step S300.

Applying the method illustrated in FIG. 4, the CGF 230 receiving FQPC 1 and RPC2 may reconstruct FQPC2 from RPC2 using FQPC 1 as a template. It is noted that the reconstruction process is sequential and thus, FQPC3 can only be reconstructed from RPC3 after FQPC2 has been reconstructed from RPC2.

The example embodiments described above emphasize the benefits and importance of including removed field indications, where applicable, in RPCs

### Enhancement to CDR Transportation Redundancy Mechanism for RPC Reconstruction

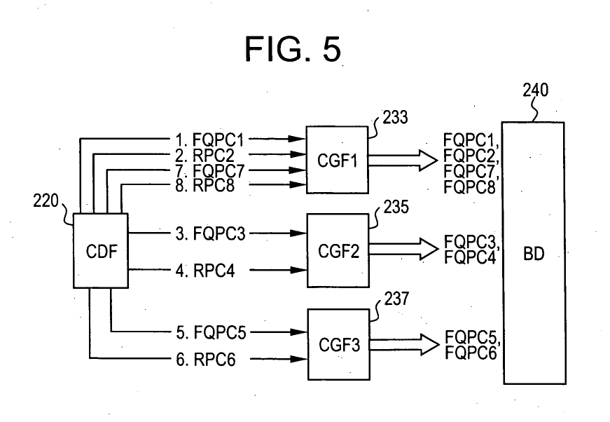

An enhancement to the CDR transportation redundancy mechanism for RPC restoration is now described referring to FIGS. 4 and 5.

Referring to FIG. 5, a CDF 220 sends partial CDRs to one or more of a first CGF 233, a second CGF 235 and a third CGF 237.

According to an example embodiment of the present invention, the CDF 220 sends a FQPC instead of an RPC each time a partial CDR is sent to a different CFG. When transferring a sequence of partial CDRs of an IMS session, if a partial CDR is transmitted to the second CGF 235 because the first CGF 233 cannot continue receiving partial CDRs, then the first partial CDR sent to the second CGF 235 shall be a FQPC. Similarly, if the second CGF 235 cannot continue receiving partial CDRs and the first CGF 233 is still unable to receive partial CDRs, the CDF 200 sends partial CDRs for the session to a third CGF 237. Once again the first partial CDR sent to the third CGF 237 is a FQPC. Because the first partial CDR received by each of the first CGF 233, second CGF 235 and third CGF 237 is a FQPC, each CGF can easily restore any subsequently received RPCs to a corresponding FQPC without contacting the other CGFs. The FQPCs are then forwarded by the first CGF 233, second CGF 235 and third CGF 237 to the BD 240.

An example is described referring to FIG. 5, wherein eight partial CDRs of a session are transferred to the three different CGFs 233, 235 and 237. Initially, in this example, the connection between CDF 220 and the first CGF 233 is active and the CDF 220 transfers the first partial CDR as FQPC 1 to the first CGF 233. Because the connection between the CDF 220 and the CGF 233 remains active, the CDF 220 transfers the second partial CDR as RPC2 to the first CGF 233. The first CGF 233 restores the second partial CDR by comparing the RPC with the FQPC of the previously received partial CDR. The obtained FQPC for the second partial CDR, FQPC2, may be forwarded to the BD 240.

In the example shown in FIG. 5, after the transfer of the second partial CDR, the connection between the CDF 220 and the first CGF 233 becomes unavailable. As such, the CDF 220 sends the next partial CDR to the second CGF 235 as FQPC3. The CDF 220 sends the fourth partial CDR to the second CGF 235 as RPC4. The second CDF restores the RPC of the fourth partial CDR to obtain the corresponding FQPC4, which may be sent to the BD 240.

The connection between the CDF 220 and the second CGF 235, then becomes unavailable in the example of FIG. 5. Accordingly, the CDF 220 sends the fifth partial CDR to the third CGF 237 as FQPC5 followed by the sixth partial CDR, which is transferred as RPC6. The sixth partial CDR is restored by the CGF 237 to obtain the FPQC of the sixth partial CDR, FQPC6.

If the connection between the CDF 220 and the third CGF 237 becomes unavailable and the connection between the CDF 220 and the first CGF 233 is available, the CDF 200 sends the seventh partial CDR to the first CDF 233 as FQPC7 and sends the eighth partial CDR of the session to the first CDG 233 as RPC8.

In the above-described example, RPC2, RPC8, RPC4 and RPC6 can be easily restored because their immediately preceding partial CDRs FQPC1, FQPC7, FQPC3 and FQPC5, respectively, are available at the same CGF.

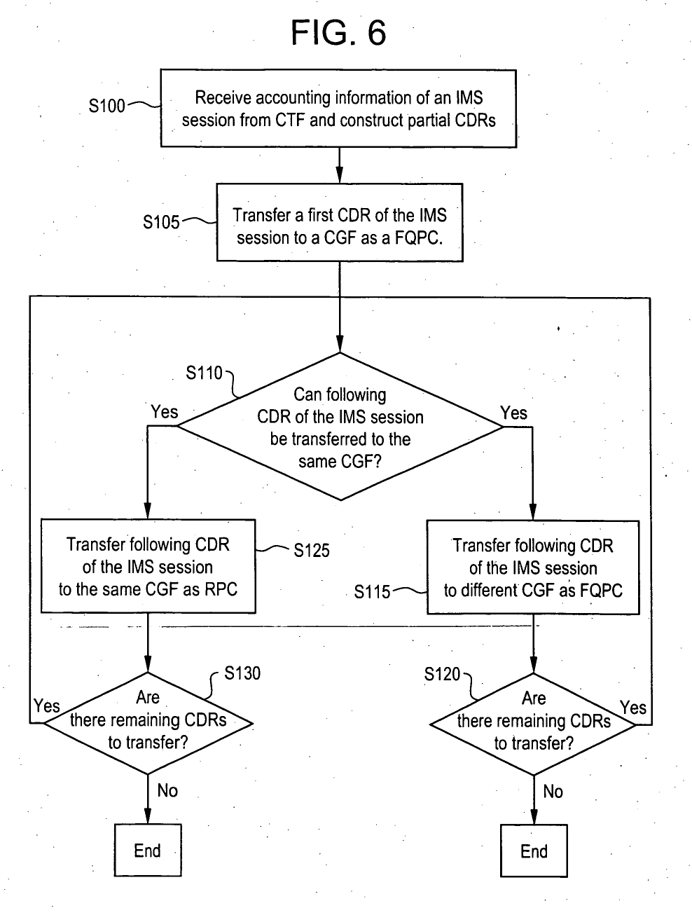

FIG. 6 is a flow chart illustrating a method of communicating CDRs performed by the CDF according to an example embodiment of the present invention, which is consistent with the above example explained referring to FIG. 5.

In Step S100, the CDF 220 receives accounting information of an IMS session from a CTF and constructs partial CDRs. In step S105, the CDF 220 transfers a first partial CDR to a CGF as an FQPC.

In step S110, the CDF 220 determines if the following partial CDR can be transferred to the same CGF. If the same CGF is unavailable, the CDF 220 transfers the following partial CDR to a different CGF as an FQPC as shown by step S115. The CDF 220 then determines if there are still partial CDRs of the session that have not been transmitted to a CGF in step S120. If there are additional partial CDRs to be transferred, the flow chart in FIG. 6 proceeds back to step S110. However, if the last partial CDR has been transferred to a CGF, then the method ends.

Further, if in step S110, the CDF 220 determines that the following partial CDR can be transferred to the same CGF as the previously transferred partial CDR, the following partial CDR is transferred to the same CGF as an RPC as shown in step S125. After step 125, the CDF 220 determines if there are still partial CDRs of the session that have not been transmitted to a CGF in step S130. If there are additional partial CDRs to be transferred, the flow chart in FIG. 6 proceeds back to step S110. However, if the last partial CDR has been transferred to a CGF, then the method ends.

Example embodiments of the present invention being thus described, it will be obvious that the same may be varied in many ways. Such variations are not to be regarded as a departure from the invention, and all such modifications are intended to be included within the scope of the invention.

What is claimed:

1. A method of communicating charging data records (CDRs) in an Internet Protocol Multimedia Subsystem (IMS), comprising:
comparing fields of a previous partial CDR to fields of a current partial CDR;
providing a removed indication in the current partial CDR for each field of the previous partial CDR that is not included in the current partial CDR; and
sending the current partial CDR.

2. The method of claim 1, further comprising:
omitting fields of the current partial CDR that match fields of the previous partial CDR, wherein
the sending step sends the current partial CDR as a reduced partial CDR.

3. The method of claim 1, wherein the previous partial CDR is a fully qualified partial CDR.

4. The method of claim 1, wherein the previous partial CDR is a reduced partial CDR.

5. A method of communicating charging data records (CDRs) in an Internet Protocol Multimedia Subsystem (IMS), comprising:
sending a first partial CDR to a first Charging Gateway Function (CGF);
determining if the first CGF remains available to receive a second partial CDR;
sending the second partial CDR to the first CGF as a reduced partial CDR if the first CGF is determined available; and
sending the second partial CDR to a second CGF as a fully qualified partial CDR if the first CGF is determined unavailable.

6. The method of claim 5, wherein the first partial CDR is a fully qualified partial CDR.

7. The method of claim 5, wherein the first partial CDR is a reduced partial CDR.

8. The method of claim 5, further comprising:
receiving accounting information of an IMS session from a Charging Trigger Function (CTF); and
constructing the first partial CDR from the accounting information.

9. The method of claim 5, further comprising:
comparing fields of the first partial CDR to fields of the second partial CDR;
providing a removed indication in the second partial CDR for each field of the first partial CDR that is not included in the second partial CDR.

10. A system for communicating charging data records (CDRs) in an Internet Protocol Multimedia Subsystem (IMS), comprising:
at least one Charging Gateway Function (CGF) receiving the CDRs; and
a Charging Data Function (CDF) comparing fields of a first partial CDR to fields of a second partial CDR, providing a removed indication in the second partial CDR for each field of the first partial CDR that is not included in the second partial CDR, and sending the second partial CDR to the at least one CGF.

11. The system of claim 10, wherein the CDR omits fields of the second partial CDR that match fields of the first partial CDR and sends the second partial CDR to the at least one CGF as a reduced partial CDR.

12. The system of claim 10, wherein the first partial CDR is a fully qualified partial CDR.

13. The system of claim 10, wherein the first partial CDR is a reduced partial CDR.

14. The system of claim 10, wherein the at least one CGF includes a first CGF and a second CGF; and
the CDF sends the first partial CDR to the first CGF, determines if the first CGF remains available to receive the second partial CDR, sends the second partial CDR to the first CGF as a reduced partial CDR if the first CGF is determined available, and sends the second partial CDR to the second CGF as a fully qualified partial CDR if the first CGF is determined unavailable.

15. The system of claim 14, wherein the first partial CDR is a fully qualified partial CDR.

16. The system of claim 14, wherein the first partial CDR is a reduced partial CDR.

17. A method of reconstructing charging data record (CDRs) in an Internet Protocol Multimedia Subsystem (IMS), comprising:
receiving a fully qualified partial CDR and a reduced partial CDR;
comparing fields of the reduced partial CDR with fields of the fully qualified partial CDR;
restoring any fields omitted from the reduced partial CDR that are included in the fields of the fully qualified partial CDR; and
removing fields of the reduced partial CDR that include a removed field indication.
